(19) United States
(12) Patent Application Publication
(10) Pub. No.: US 2004/0033024 A1
(43) Pub. Date: Feb. 19, 2004

(54) Linear diode laser array light coupling apparatus

(75) Inventors: Jeffrey Thomas Remillard, Ypsilanti, MI (US); Willes H. Weber, Ann Arbor, MI (US); Timothy Fohl, Carlisle, MA (US)

Correspondence Address: KEVIN G. MIERZWA, ARTZ & ARTZ, P.C., 28333 TELEGRAPH ROAD, SUITE 250, SOUTHFIELD, MI, 48034, US

(73) Assignee: Ford Global Technologies, Inc., Dearborn, MI

(21) Appl. No.: 10/064,758

(22) Filed: Aug. 14, 2002

(51) Int. Cl. G02B 6/30

(52) U.S. Cl. 385/49

(57) ABSTRACT

A light coupling apparatus for coupling a linear diode laser array to an optical fiber. The apparatus includes a cylindrical lens positioned adjacent and substantially parallel to the linear diode laser array. The cylindrical lens has a length substantially equal to the length of the linear diode laser array, and receives emitted light from the plurality of diode lasers within the linear diode laser array to collimate the light. The collimated light is received by a wedge-shaped coupling element between the cylindrical lens and the optical fiber. The coupling element has a length (L) extending from an input surface to an output surface. The input surface defines a radius of curvature along a height (h) that is substantially equal to the cylindrical lens length. The coupling element tapers from its input surface to its output surface. The input surface also has an associated width (w1), and the output surface has an associated width (w2). The input surface width is substantially equal to a diameter of the cylindrical lens, and the output surface width is substantially equal to a diameter of the input end of the optical fiber.

### BACKGROUND OF INVENTION

The present invention relates to a linear diode laser array light coupling apparatus and, in particular, concerns a light coupler for carrying laser light from a linear diode array to an optical element using an optical fiber.

Conventional lighting systems used in automotive vehicle applications such as headlights and taillights utilize an incandescent bulb with a reflector. The light emitted from the incandescent bulb is generally collimated by the reflector. The incandescent bulb is used to generate light in the visible spectrum for headlight and taillight applications. In other vehicle applications, such as active night vision systems, near-infrared light is required that is compatible with solid-state CCD or CMOS cameras to illuminate a region proximate the vehicle.

Advances in solid-state lasers have given rise to thin-sheet lighting systems for use in taillight and active night vision systems. The thin-sheet systems require less space than traditional bulb and reflector systems. Furthermore, laser diodes are more energy efficient and reliable than incandescent bulbs. A challenge in thin-sheet lighting systems is to rapidly spread the laser light over a sufficiently wide area to meet spatial illumination requirements for good visibility and, at the same time, eye safety requirements as mandated under laws governing such applications.

U.S. patent application Ser. No. 09/688,992 entitled “Thin-Sheet Collimation Optics For Diode Laser Illumination Systems For Use In Night Vision and Exterior Lighting Applications” filed Oct. 17, 2000 describes thin-sheet collimation optics which can be used to produce eye-safe diode laser-based headlamps for night vision applications. Other patents describe diode laser-based signal lamps, which use thin-sheet optics to form beam patterns. To minimize the optical lamp depth, it is advantageous to convey the laser light from the diode laser source to the optical lamp using an optical fiber. Performance, styling, and packaging advantages of such thin-sheet optical elements can be improved through the use of a fiber-coupled diode laser array.

In light applications such as the foregoing, it is necessary to couple the diode laser array to a multimode optical fiber. Typically, the optical fiber is butt-coupled to each laser diode such that the optical fiber is as close as possible to the laser diode. This is desirable because the laser diode output has a high divergence angle in the direction perpendicular to the diode junction. Thus, the optical fiber must be placed very close to the diode laser to efficiently receive the emitted light. Accurate placement of the optical fiber within small tolerances required for efficient coupling is difficult to achieve.

Accordingly, a variety of techniques have been disclosed for coupling the output of a multiple diode laser array into a multi-mode optical fiber. For example, U.S. Pat. No. 5,436,990 discloses a coupling method using a single, small diameter optical fiber to collimate the fast axis of each diode laser within the array. The collimated output of each laser is then butt-coupled to its own optical fiber. Thus, the coupling technique requires the precise positioning of numerous optical fibers one optical fiber for each diode laser within the array. Other known coupling techniques require the positioning of individual microlenses to condition the output of each diode laser within the array or the reception by either another array of lenses or a single lens to direct the light into a single optical fiber.

Each of these known light coupling techniques requires the precise position of either lenses, fibers, or both in front of each individual diode laser within the array. Accordingly, there is a need for an uncomplicated, inexpensive fiber coupling method or apparatus that does not require precise alignment of either lenses or fibers to couple a linear diode laser array to an optical fiber.

### SUMMARY OF INVENTION

The present invention provides a light coupling apparatus for coupling a linear diode laser array to an optical fiber. In one embodiment of the invention, the apparatus includes a cylindrical lens positioned adjacent and substantially parallel to the linear diode laser array. The cylindrical lens has a length substantially equal to the length of the linear diode laser array, and receives emitted light from the plurality of diode lasers within the linear diode laser array to collimate the light. The collimated light is received by a wedge-shaped coupling element between the cylindrical lens and the optical fiber. The coupling element has a length (L) extending from an input surface to an output surface. The input surface defines a radius of curvature along a height (h) which is substantially equal to the cylindrical lens length. The coupling element tapers from its input surface to its output surface. The input surface also has an associated width (w1), and the output surface has an associated width (w2). The input surface width is substantially equal to a diameter of the cylindrical lens, and the output surface width is substantially equal to a diameter of the input end of the optical fiber.

In another embodiment of the invention, the cylindrical lens is eliminated, and its function is performed by the entrance surface of the wedge-shaped coupling element. The entrance surface is a Fresnel-type sequence of facetted, curved surfaces in the direction along the height (h). In this direction, the curvature of each facet along the height (h) is the same as in the first embodiment. In the direction along the width (w1), each facetted surface has a convex curvature so as to collimate the fast axis of the diode laser emission. The entrance surface of the wedge-shaped coupling element is positioned approximately at the same distance (d1) from the diode laser array as was the cylinder lens in the first embodiment.

The present invention is advantageous in that it provides an uncomplicated and inexpensive fiber coupling apparatus which does not require precise alignment of multiple lenses or fibers to couple a single multi-mode optical fiber to a diode laser array. The present invention avoids the critical placement problems associated with prior light coupling techniques.

Other advantages and features of the invention will become apparent to one of skill in the art upon reading the following detailed description with reference to the drawings illustrating features of the invention by way of example.

### BRIEF DESCRIPTION OF DRAWINGS

For a more complete understanding of this invention, reference should now be made to the embodiments illustrated in greater detail in the accompanying drawings and described below by way of examples of the invention.

In the drawings:

FIG. 1 is a schematic block diagram of a night vision system in which the present invention may be used to advantage.

FIG. 2 is a perspective view of an emission pattern of one diode laser within an array of diode lasers.

FIG. 3 is a side view of a linear diode laser array light coupling apparatus in accordance with one embodiment of the present invention.

FIG. 4 is a top view of the linear diode laser array light coupling apparatus of FIG. 3.

FIG. 5 is a side view of a linear diode laser array light coupling apparatus in accordance with a second embodiment of the present invention.

FIG. 6 is a top view of the linear diode laser array light coupling apparatus of FIG. 5.

### DETAILED DESCRIPTION

While the present invention is described with respect to a light coupling apparatus for a linear diode laser array within the environment of an active night vision system of a vehicle, the present invention may be adapted and utilized for numerous other applications including headlamp, tail lamp, and signal lamp illumination applications as well as non-vehicle related illumination applications wherein it is desirable to couple an array of laser light sources to a single multi-mode optical fiber.

In the following description, various operating parameters and components are described for one constructed embodiment. These specific components and parameters are included as examples and are not meant to be limiting.

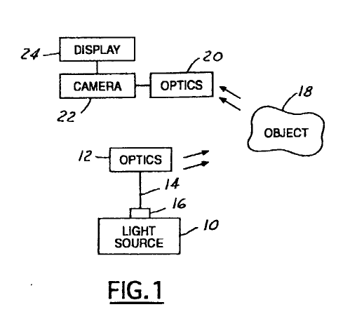

Referring now to the drawings wherein like reference numerals are used to identify identical components in the various views, FIG. 1 illustrates a schematic block diagram of an active night vision system for a vehicle wherein the present light coupling apparatus may be used to advantage. In this example, a light source 10 is used to generate near-infrared light. An optical element 12, such as a thin-sheet optical element, receives the light from the light source 10 by way of a fiber optic cable 14. The light source 10 is connected to a first end of the fiber optical cable 14 by a light coupler 16 in accordance with the present invention. The fiber optic cable 14 is utilized to transmit light from the light source 10 to the optical element 12. The fiber optic cable is a single multi-mode optical fiber having a diameter of <1 mm and a numerical aperture of 0.15-0.4, for example.

The optical element 12 receives the light from the fiber optic cable 14 through an input surface, conditions the light by reflection to form a desired beam pattern, and transmits the light through an output surface to illuminate a region proximate the vehicle such as in a forward direction of travel. The optics 12 may include additional diffusers, lenses, diffractive optics, or any other optical devices adjacent or adjoining the output surface to manipulate the laser light to create a desired illumination pattern ahead of the night vision system.

Light emitted from the optical elements 12 illuminates objects such as object 18 within the field-of-view of the night vision system. Object 18 reflects the laser light back toward the night vision system. Optical elements 20 process the light reflected from object 18 and communicate desired light data to a camera 22. The camera 22 processes the light data and presents it to a display 24 such that the object information can be made known to the system user. Optics 20 typically include a narrow band filter to shield the camera 22 from light outside of the range of interest which is typically the near-infrared range.

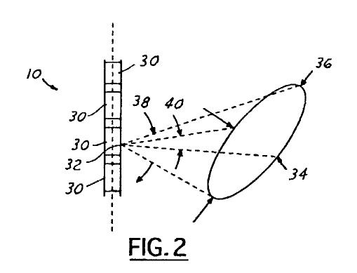

Referring now to FIG. 2 there is shown a perspective view of an emission pattern of one of the diode lasers within the linear diode laser array comprising the light source 10 of FIG. 1. The light source 10 comprises a linear diode laser array that includes a plurality of laser diodes 30. The plurality of diode lasers 30 are lineally spaced and each includes an emitting aperture 32. The emitting aperture 32 represents the emitting end of an optical resonator having dimensions that are substantially equal to the active junction area of the diode laser. Each diode laser in the linear array emits light along a slow axis 34 and a fast axis 36. The fast axis 36 is associated with a first divergent emission angle 38 and the slow axis 34 is associated with a second divergent emission angle 40. The ratio of divergence between the first and second divergent emission angles 38, 40 is approximately 3:1, with typical values for the first divergent emission angle 38 and second divergent emission angle 40 being 35° and 10°, respectively. The first and second divergent emission angles 38 and 40 may be larger or smaller, however, depending upon the type and design of the laser light source 30. Also, the first and second divergent emission angles 38, 40 are normal to each other, with the laser light generally diverging more rapidly along the fast axis than the slow axis. Further, the fast axis is generally perpendicular to the diode junction. With regard to the linear diode laser array, an exemplary rectangular dimension for each emitting aperture 32 is approximately 1×80 microns and an exemplary laser diode spacing is on the order of 200 microns. The entire linear diode laser array may be on the order of one centimeter in length, for example.

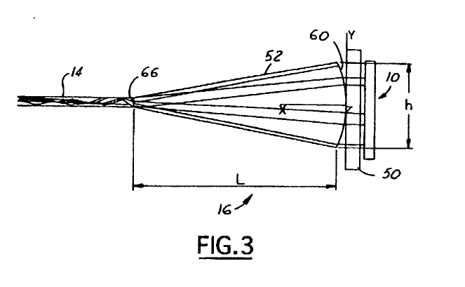

Referring now to FIG. 3, there is shown a side view of a linear diode laser array light coupling apparatus 16 in accordance with one embodiment of the present invention. The coupling apparatus 16 includes a cylindrical lens 50 and a tapered, wedge-shaped coupling element 52 between the diode laser array 10 and the multi-mode optical fiber 14. The cylindrical lens 50 is located adjacent the diode laser array 10 substantially abutting the plurality of emitting apertures associated with the plurality of diode lasers within the array 10. The cylindrical lens 50 acts to collimate light emitted from the diode laser array for reception by the coupling element 52.

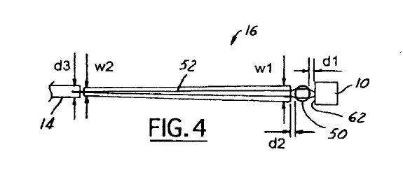

Referring now to FIG. 4, there is shown a top view of the linear diode laser array light coupling apparatus of FIG. 3. The cylindrical lens 50 is preferably a glass or polycarbonate material and has a circular cross-section. Other cross-sectional shapes, however, such as elliptical or hyperbolic, could also be used for the cylindrical lens 50. As shown in FIG. 4, the cylindrical lens is placed at a distance d1 from the diode laser array 10. Likewise, the coupling element 52 is placed at a distance d2 from the cylindrical lens 50. The values for d1 and d2 depend upon the index of refraction for the cylindrical lens 50 as well as its radius of curvature. Preferably, however, the values of d1 and d2 should be as small as possible to increase the efficiency of the light coupling. In cases where collimation of the diode laser light is not desirable, such as when refocusing of the divergent emission from the diode laser is desired, the distance d1 between the diode laser array and the cylindrical lens may be varied by known methods to achieve the desired light behavior, or the cross-sectional shape of the cylindrical lens 50 may be modified to be something other than circular. In addition, the distance d2 between the cylindrical lens 50 and coupling element 52 may be varied to achieve various desired focusing patterns for the emitted diode laser light. Preferably, the length of the cylindrical lens 50 is greater than or equal to the length of the diode laser array and the height (h) of the input surface 60 of the coupling element 52. In addition, the diameter of the cylindrical lens 50 is preferably greater than or equal to the width of the emitting surface 62 of the diode laser array 10. As the distance d1 increases, the diameter of the cylindrical lens preferably increases to redirect the rapidly diverging light towards the input surface 60 of the coupling element 52.

The coupling element 52 is preferably glass or polycarbonate material or other suitable plastic. The coupling element 52 tapers along its length (L) from its input surface 60 to the output surface 66 which adjoins the input of the multimode optical fiber 14. The width w1 of the input surface 60 of the coupling element 52 is less than or equal to the diameter of the cylindrical lens 50. The width w2 of the output surface 66 can be less than or equal to the width w1 of the input surface. The width w2 of the output surface 66 is preferably also less than the diameter d3 of the multimode optical fiber 14. Thus, as shown in FIG. 3, the coupling element 52 preferably tapers from its input surface 60 to its output surface 66 along its length L and, as shown in FIG. 4, the coupling element either is of a constant width (w1=w2) or tapers from its input surface to its output surface along the length L (w1>w2). The interior surfaces of the coupling element are preferably configured and/or coated to achieve total internal reflection of the laser light toward the input end of the optical fiber 14.

In one example, the cylindrical lens 50 is approximately 1 to 3 mm in diameter, the widths of the coupling element 52 at its input and output (w1, w2) are 1 to 3 mm, the length (L) of the coupling element 52 is approximately 30 mm and the height (h) of the coupling element 52 is approximately 10 mm. The multimode optical fiber is a large diameter optical fiber that is approximately 1 to 3 mm in diameter.

In operation, light emitted from the diode laser array is collimated by the cylindrical lens 50. Thus, the divergence of each diode laser within the array along its fast axis is redirected by the cylindrical lens to have a divergence angle of approximately zero (collimated light). The parallel collimated light is then received by the input surface 60 of the coupling element 52. The input surface 60 of the coupling element 52 has a predetermined radius of curvature to direct the light towards the output surface 66 and, hence, the input of the multimode optical fiber 14. The length (L) and height (h) of the coupling element 52 is selected to ensure that the angular spread of light within the coupling element 52 matches the acceptance angle of the optical fiber 14. The dimensions for L, h, w1, and w2 are also selected to minimize reflection of the laser light from the sides of the coupling element 52.

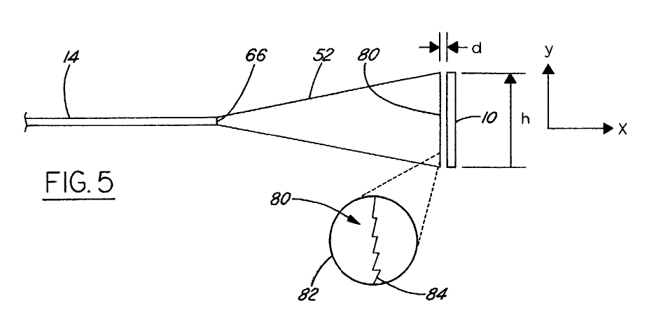

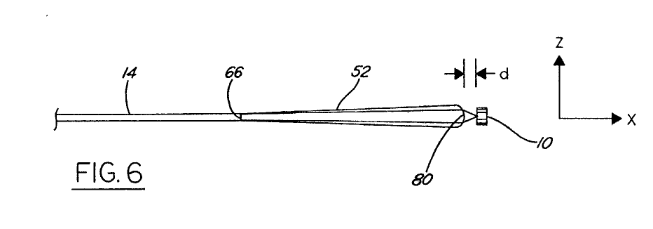

Referring now to FIG. 5, there is shown a side view of a linear diode laser array light coupling apparatus in accordance with a second embodiment of the present invention. Like features of the second embodiment are identified with the same reference numerals as the light coupling apparatus of FIGS. 3 and 4. The only difference between the embodiment of FIGS. 5 and 6 and the embodiment shown in FIGS. 3 and 4 is the elimination of the cylindrical lens, and the contours of the input surface 80 of the coupling element 52. In the y direction, the input surface 80 of coupling element 52 is facetted as shown schematically in the magnified view 82. the facet angle 84 in the y direction of each facet is chosen such that light emitted from each diode emitter is refracted toward the exit aperture 66. These facets act in the same way in the y direction as the curved input surface 60 of FIG. 3.

FIG. 6 shows a top view of the light coupling apparatus of FIG. 5. The spacing d1 and the curvature of the input surface 80 in the z direction are configured such that light diverging in the fast axis is substantially collimated and directed toward the exit aperture 66. The input surface 60 thus acts similar to the cylindrical lens in the first embodiment of the invention.

The combination of the cylindrical lens 50 and coupling element 52 in the first embodiment, or the use of a complex entrance surface for the coupling element 52 in the second embodiment permit a relatively high efficiency light coupling system without the need to precisely position a plurality of optical fibers or microlenses. The coupling efficiency realized by the present invention is satisfactory for automotive lighting applications including night vision system illuminating sources, convenience lighting, and head lamp and tail lamp beam forming applications.

From the foregoing, it can be seen that there has been brought to the art a new and improved light coupling apparatus which has advantages over prior light coupling devices. While the invention has been described in connection with one or more embodiments, it should be understood that the invention is not limited to those embodiments. On the contrary, the invention covers all alternatives, modifications and equivalents as may be included within the spirit and scope of the appended claims.

1. A light coupling apparatus for coupling a linear diode laser array to an optical fiber comprising a wedge-shaped coupling element having a height (h) substantially equal to a length defined by said linear diode laser array, said coupling element having a length (L) extending from an input surface to an output surface, said input surface receiving emitted light from a plurality of diode lasers within said linear diode laser array, said input surface having a first width (w1) facetted in a direction along the height (h) to direct said light towards said output surface having a second width (w2), said output surface being curved in a direction perpendicular to said height (h) to substantially collimate said light.

2. The light coupling apparatus of claim 1 wherein said first width (w1) is greater than or equal to said second width (w2).

3. The light coupling apparatus of claim 2 wherein said second width (w2) is substantially equal to a diameter of said optical fiber.

4. A method of coupling the output of a linear diode laser array into an end of an optical fiber comprising the steps of:
optically coupling along a linear axis spaced at a first distance (d1) from said linear diode laser array a wedge-shaped coupling element having a height (h) substantially equal to a length defined by said linear diode laser array, said coupling element receiving emitted light from a plurality of diode lasers within said array and directing said light toward an output surface having a second width (w2) by way of an input surface having a first width (w1) facetted in a direction along said height (h) and curved in a direction perpendicular to said height (h); and
optically coupling light from said output surface into an end of the optical fiber, said optical fiber having a diameter substantially equal to said second width (w2).

5. A method according to claim 4 wherein said first width is greater than or equal to said second width.

6. A light coupling apparatus for coupling a linear diode laser array to an optical fiber comprising:
a cylindrical lens positioned adjacent and substantially parallel to the linear diode laser array, said cylindrical lens having a length substantially equal to a length of the linear diode laser array, said cylindrical lens receiving emitted light from a plurality of diode lasers within said linear diode laser array and collimating said light; and
a wedge-shaped coupling element between said cylindrical lens and said optical fiber, said coupling element having a length (L) extending from an input surface to an output surface, said input surface having a radius of curvature along a height (h), said height being substantially equal to said cylindrical lens length, said coupling element tapering from said input surface to said output surface, said input surface having an associated first width (w1) and said output surface having an associated second width (w2), the first width being substantially equal to a diameter of said cylindrical lens, and the second width being substantially equal to a diameter of said optical fiber.

7. The light coupling apparatus of claim 6 wherein said first width is greater than or equal to said second width.

8. The light coupling apparatus of claim 6 wherein said cylindrical lens has a circular, elliptical or hyperbolic cross-section.

9. The light coupling apparatus of claim 6 wherein said coupling element length (L) is approximately 10 mm and said first and second widths are approximately 1 to 3 mm.

10. The light coupling apparatus of claim 6 wherein said cylindrical lens is at a first distance (d1) from said linear diode laser array and said input surface of said coupling element is at a second distance (d2) from said cylindrical lens and wherein said first and second distances are substantially equal.

11. The light coupling apparatus of claim 6 wherein said radius of curvature of said coupling element input surface is configured to minimize reflection received light from interior sides of said coupling element.

12. The light coupling apparatus of claim 11 wherein said coupling element length (L) and said input surface height (h) are configured such that an angular spread of light within said coupling element matches an acceptance angle of said optical fiber.

13. A lighting apparatus comprising:
a linear diode laser array comprising a plurality of spaced-apart diode lasers each emitting divergent laser light;
a cylindrical lens positioned at a first distance (d1) and substantially parallel to the linear diode laser array, said cylindrical lens having a length substantially equal to a length defined by said plurality of diode lasers, said cylindrical lens receiving emitted light from said plurality of diode lasers and collimating said light; and
a wedge-shaped coupling element at a second distance (d2) from said cylindrical lens, said coupling element having a length (L) extending from an input surface to an output surface, said input surface having a radius of curvature along a height (h), said height being substantially equal to said cylindrical lens length, said coupling element tapering from said input surface to said output surface, said input surface having an associated first width (w1) and said output surface having an associated second width (w2), the first width being substantially equal to a diameter of said cylindrical lens; and
an optical fiber adjacent said output surface of said coupling element, said second width being substantially equal to a diameter of said optical fiber.

14. The light coupling apparatus of claim 13 wherein said first width is greater than or equal to said second width.

15. The light coupling apparatus of claim 13 wherein said cylindrical lens has a circular, elliptical or hyperbolic cross-section.

16. The light coupling apparatus of claim 13 wherein said coupling element length (L) is approximately 10 mm and said first and second surface widths are approximately 1 to 3 mm.

17. The light coupling apparatus of claim 13 wherein said first and second distances are substantially equal.

18. A method of coupling the output of a linear diode laser array into an end of an optical fiber comprising the steps of:
optically coupling along a linear axis spaced at a first distance (d1) from said linear diode laser array a cylindrical lens having a length substantially equal to a length defined by said linear diode laser array, said cylindrical lens receiving emitted light from a plurality of diode lasers within said array and collimating said light;
optically coupling the collimated light from said cylindrical lens into a wedge-shaped coupling element, said coupling element positioned at a second distance (d2) from said cylindrical lens and having a length (L) extending from an input surface to an output surface, said input surface having a radius of curvature along a height (h), said height being substantially equal to said cylindrical lens length, said coupling element tapering from said input surface to said output surface, said input surface having an associated first width (w1) and said output surface having an associated second width (w2), the first width being substantially equal to a diameter of said cylindrical lens; and
optically coupling light from said output surface into an end of the optical fiber, said optical fiber having a diameter substantially equal to said second width.

19. The method of claim 18 wherein said first width is greater than or equal to said second width.

20. The method of claim 18 wherein said cylindrical lens has a circular, elliptical or hyperbolic cross-section.
